(19) United States
(12) Patent Application Publication
(10) Pub. No.: US 2006/0072880 A1
(43) Pub. Date: Apr. 6, 2006

(54) Opto-electro cable and related apparatus

(76) Inventor: Tsung-Ming Cheng, Taipei (TW)

Correspondence Address: TSUNG-MING CHENG;c/o PATRICK POON, 525 E. LEMON AVENUE, ARCADIA, CA, 91006, US

(21) Appl. No.: 10/959,840

(22) Filed: Oct. 6, 2004

(51) Int. Cl. G02B 6/36

(52) U.S. Cl. 385/88; 385/92; 385/76; 385/77; 385/78; 385/86

(57) ABSTRACT

A composite cable assembly comprises optical fiber and metal wire, having a composite connector at each end of the cable. The connector houses the optical fiber at its core, with an elongated cylinder protruding from a protective grip forming an insertion guide and functioning as an electrical conductor. An opto-electro adaptor has an open passageway for connector insertion, an optical device at the end of the passageway, an elongated cylinder as insertion guide and electrical conductor, a sheet metal as electrically conductive element.

### CROSS-REFERENCE TO RELATED APPLICATIONS

This application cites the optical digital audio system disclosed in my patent application Ser. No. 10/867090;

### STATEMENT REGARDING FEDERALLY SPONSORED R & D

Not Applicable

### REFERENCE TO SEQUENCE LISTING, A TABLE, OR A COMPUTER PRGRAM LISTING COMPACT DISK APPENDIX

Not Applicable

### BACKGROUND OF THE INVENTION

This invention relates to optical fiber cable and connectors, particularly to composite assembly of optical fiber and electrical wire, and related components.

With advances in optical technologies, application of optical fiber transmission for audio, video, data and the like has soared in recent years. Amongst, a growing number of communication, audio, and video equipments has utilized optical fiber as the signal transmission medium in place of conventional metal-type wire. Conventional metal-type wire is prone to distortion and signal loss, whereas optical fiber is a proven transmission medium that can effectively retain the original signal integrity, and is capable of handling significantly higher bandwidth. However, unlike certain conventional metal-type wire, optical fiber does not have the dual function of also carrying electrical current to provide power for the equipment at receiving end of the signal transmission. The equipment has to have separate mean for power supply.

As an example: Conventional speaker wire can also carry sufficient electrical power to operate the audio speaker while transmitting audio signal; on the other hand, a speaker that receives audio signal via optical fiber requires a separate power source. Despite obvious advantages of optical fiber, having to handle an additional cable (the power cord) for each speaker is inconvenient and having to find an electrical outlet for each speaker can be difficult, especially in the situation of installing a multi-channel audio video system that comprises of multiple speaker sets.

### BRIEF SUMMARY OF THE INVENTION

In accordance with an embodiment of the present invention an opto-electro cable comprises an assembly of an optical fiber cable and two metal wires, with one connector at each end of the composite cable. The connector comprises an elongated cylinder protruding from an insulated housing, with the optical fiber from the composite cable extends through and fits inside the elongated cylinder in such a way that the optical fiber is properly exposed from the top opening of the elongated cylinder in a ready position for optical signal transmission when engaged. Said elongated cylinder comprises of two electrically conductive layers with insulation lining sandwiching between the layers. Each electrically conductive layer is connected to the corresponding conductive layer at the other end of the composite cable by one metal wire of the composite cable.

As a related apparatus in accordance with the present invention, an opto-electro adaptor comprises of an insulated housing with an open passageway for insertion of the opto-electro connector. An elongated cylinder is positioned in the insertion passageway in such a way that, when engages, the optical fiber of the connector will be guided through the core of the elongated cylinder and held in proper position for communicating with an optical device situated in the rear wall of the passageway. The elongated cylinder also acts as electrical conductor; an electrically conductive sheet metal is affixed to an interior section of the passageway wall to form another electrical conductor.

This invention combines optical fiber and metal wires into one cable installation that transmits optical signal and delivers electrical current simultaneously, minimizing handling of cables and plugs. More importantly, it removes hassles of having to locate a separate power source for the equipment that operates the optical signal input. In the example of audio speaker system, the opto-electro cable according to this invention enables user to take full advantages of high-bandwidth and virtually zero-distortion optical audio signal transmission, while maintaining the convenience of also delivering electrical power as conventional speaker wire.

### BRIEF DESCRIPTION OF THE SEVERAL VIEWS OF THE DRAWING

FIG. 1 shows an opto-electro cable with a connector at each end according to a typical embodiment of this invention.

FIG. 2 shows a high-angle close up view of the connector of FIG. 1 FIG. 3 shows a cross-sectional view of the connector of FIG. 1

FIG. 4 shows an opto-electro adapter according to a typical embodiment of this invention.

FIG. 5 shows a cross-sectional view of the adapter of FIG. 4

FIGS. 6A and 6B show cross-sectional views of the connector and the adaptor in ready-to-engage position (FIG. 6A) and in fully-engage position (FIG. 6B)

FIGS. 7A and 7B show cross-sectional views of the connector and the adaptor in ready-to-engage position (FIG. 7A) and in fully-engage position (FIG. 7B) with stabilizing mechanism.

### REFERENCE NUMERALS IN DRAWINGS

10 composite cable
11 optical fiber
12 metal wire
13 second metal wire
20 opto-electro connector
21 dual-layer elongated cylinder
22 outer conductive layer
23 insulation lining
24 inner conductive layer
25 insertion groove
26 insulated housing
27 positioning convex point
30 opto-electro adaptor
31 insulated housing
32 insertion passageway
33 adaptive elongated cylinder
34 contact pin (A)
35 sheet metal
36 contact pin (B)
37 optical device
38 positioning concavity

### DETAILED DESCRIPTION OF THE INVENTION

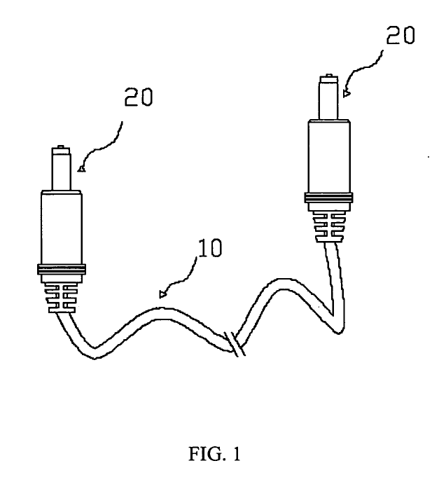

A typical embodiment of the opto-electro cable of the present invention is illustrated in FIG. 1. The opto-electro cable includes an assembly of an optical fiber cable and two insulated metal wires, with one opto-electro connector 20 at each end of the composite cable 10. The composite assembly of an optical fiber and two electric wires can be done in various formats; in this typical embodiment, the optical fiber and the two individually insulated electric wires are bonded together and wrapped with a protective coating.

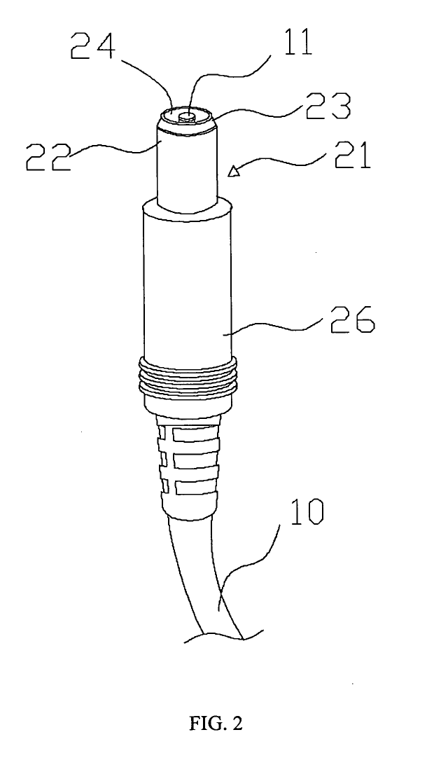

A connector of the opto-electro cable is illustrated in FIG. 2; a cross-sectional view of the connector is illustrated in FIG. 3. In a typical embodiment, the connector comprises a dual-layer elongated cylinder 21 protruding out from an insulated housing 26. The optical fiber 11 of the composite cable 10 extends through the core of the elongated cylinder, positioning in such a way that optical signal can be transmitted via the top opening of the elongated cylinder when engages. The insertion groove 25 between the optical fiber and the interior wall of the elongated cylinder is designed for proper insertion and alignment of the optical fiber with the adapter mating device. Each layer of the elongated cylinder is electrically conductive, with insulation lining 23 sandwiching between the two layers. The outer conductive layer 22 connects to one metal wire 12 of the composite cable that leads to a corresponding conductive layer at other end of the cable; likewise, the inner conductive layer 24 connects to the second metal wire 13 of the composite cable that leads to the corresponding conductive layer at the other end of the cable.

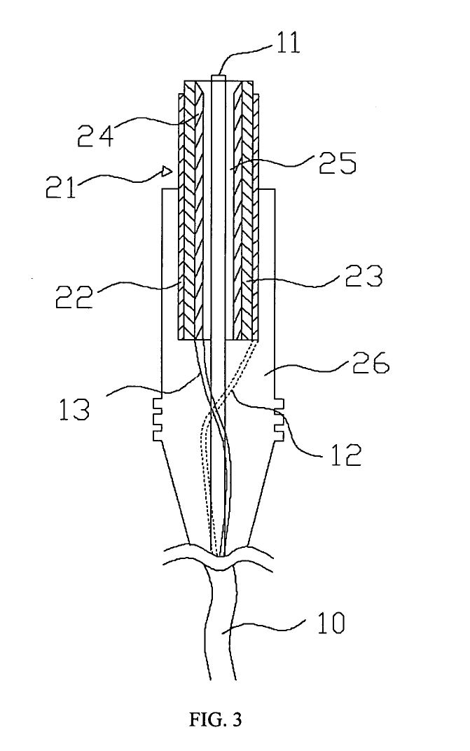

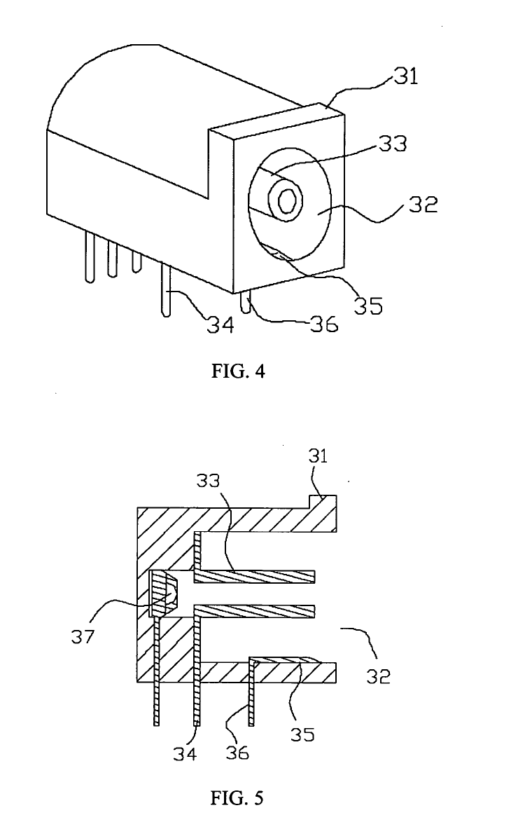

A typical embodiment of opto-electro adapter is illustrated in FIG. 4; a cross-sectional view of the connector is illustrated in FIG.5. In a typical embodiment, the opto-electro adapter comprises an insulated housing 31 that forms an insertion passageway 32 for the opto-electro connector. An optical device 37 is placed in the rear wall of the passageway, facing toward the front opening. An adaptive elongated cylinder 33 with proper magnitude to fit into the insertion groove of the opto-electro connector is placed in the passageway, with one open end toward said optical device and another open end toward the front opening, positioning for slidily engaging with the connector, thereby aligning the optical fiber of the connector to properly aim at said optical device for optical communication. The adaptive elongated cylinder is electrically conductive with contact pin (A) 34 extending out of insulated housing through the passage wall. A sheet metal 35 is affixed onto a section in the passageway wall, in such a way that the sheet metal will press against the electrically conductive surface of the connector when engaged, serving as an electrically conductive element. The conductive sheet metal has contact pin (B) 36 extends through the passageway wall to reach outside the housing. The opto-electro adapter is to be mounted on equipment as an input/output port for optical signal and electrical current.

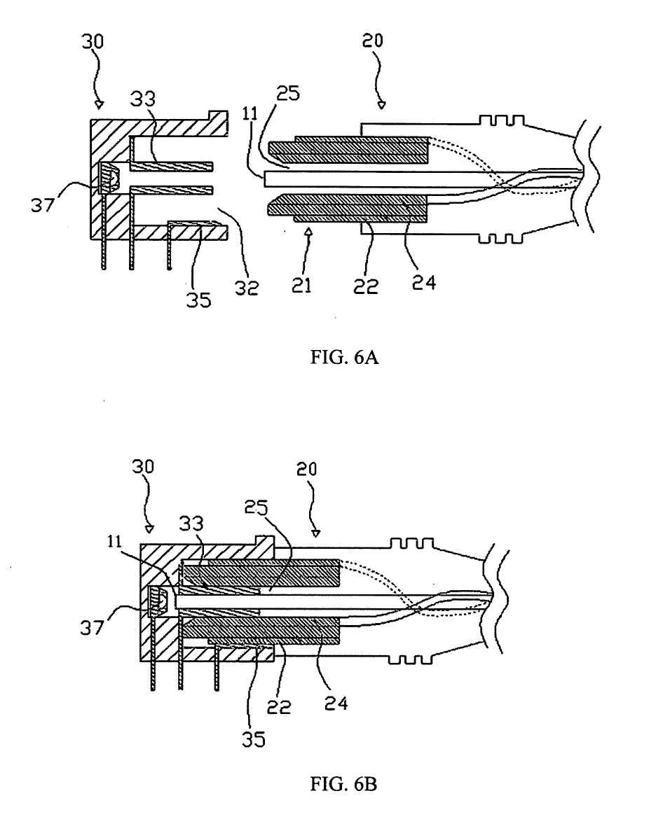

FIG. 6A and FIG. 6B show the cross-sectional views of an opto-electro connector 20 and an opto-electro adapter 30 in ready-to-engage position and in fully-engaged position. The dual-layer elongated cylinder 21 of the connector plugs into the insertion passageway 32 of the adaptor. The adaptive elongated cylinder 33 in the passageway fits into the insertion groove 25, thereby aligning the optical fiber 11 to aim properly at the optical device 37 at the rear wall of the passageway for precise optical signal communication. The inner conductive layer 24 of the connector is in fitting contact with the adaptive elongated cylinder of the adaptor, whereas the conductive sheet metal 35 at the passageway of the adaptor presses against the outer conductor layer 22 of the connector, thereby electrically connecting the two engaging apparatus.

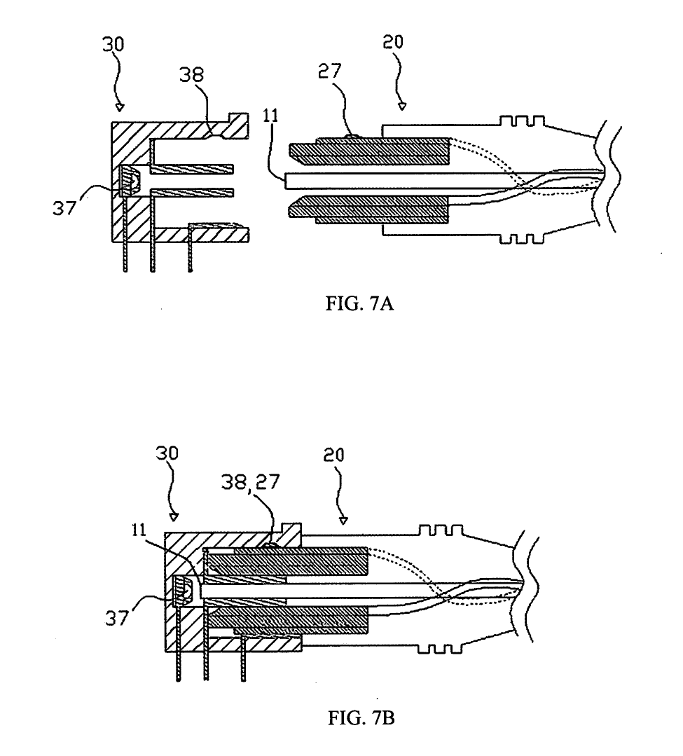

In another typical embodiment, a set of stabilizing mechanism is added to the opto-electro connector and adaptor respectively to further ensuring proper engagement of the apparatuses. An example is shown in FIG.7A and FIG.7B, a positioning convex point 27 is constructed on the elongated cylinder of the opto-electro adaptor 20, and a positioning concavity 38 is made in a corresponding area in the passageway wall of the opto-electro adaptor 30 for slidily interlocking with the convex point, thereby locking the connector and adaptor in position for proper engagement of the optical fiber 11 to optically connect with the optical device 37 in the apparatus. Another example of embodiment can instead have the convex point on the adaptor, and the matching concavity on the connector.

The opto-electro cable and related apparatus of this invention encompasses dual functions of optical signal transmission and electrical power transmission in one installation. This invention combines optical fiber and electrical wire into one cable that minimizes handling of cables and plugs, and removes the hassles of having to locate a separate power source for the equipment that operates at one end of the optical signal transmission. In the example of audio speaker system, the opto-electro cable according to this invention provides advantages over conventional speaker wire with high-bandwidth and virtual zero-distortion optical audio transmission, while maintaining the convenience of also functioning as the medium for electrical source.

Although the description above contains many specificities, these should not be construed as limiting the scope of the invention but as merely providing examples of the presently preferred embodiment of this invention. For example, the composite cable can comprise of one or multiple metal wire(s), with matching single-layer or multiple-layer elongated cylinder in the opto-electro connector and matching number of conductive counterparts in the opto-electro adaptor.

Thus the scope of the invention should be determined by the appended claims and their legal equivalents, rather than by the examples given.

I claim:

1. A composite cable for optical signal and electrical current transmission comprising:
a. an assembly of an optical fiber and at least one metal wire bonded together to form a single holding,
b. a connector at each end of the cable assembly having an elongated cylinder protruding from an insulated housing for insertion to a mating device,
c. said optical fiber extending from said cable assembly and situating inside said elongated cylinder in a ready position to engage in optical signal communication through the top opening of the cylinder,
d. said elongated cylinder comprising at least one electrically conductive layer connecting to the metal wire of said cable,
whereby said cable will transmit optical signal and electricity simultaneously from one end of the cable to another with one cable connection.

2. An opto-electro connector that combines an optical fiber and at least one metal wire into a single installation comprising:
a. an elongated cylinder with adequate magnitude to house said optical fiber at center, thereby positioning said optical fiber for proper engagement to a mating device for optical communication through the top opening of the cylinder,
b. said elongated cylinder comprising at least one electrically conductive layer connecting to said metal wire,
c. an insulated housing wrapping around the bottom portion of said elongated cylinder thereby anchoring connection to said metal wire and insertion of said optical fiber while providing a protective grip for convenient handling,
whereby connection to a mating device can be made for optical fiber and electric wire with one single connector.

3. The opto-electro connector of claim 2 further including a stabilizing mechanism comprising a convex point on said elongated cylinder that slidily locks into a corresponding concavity in said mating device when engages, whereby ensuring proper engagement of the connector and said mating device.

4. The opto-electro connector of claim 2 further including a stabilizing mechanism comprising a concavity on said elongated cylinder that slidily locks into a corresponding convex point in said mating device when engages, whereby ensuring proper engagement of the connector and said mating device.

5. An opto-electro adaptor for connection to a mating device that includes optical fiber and electrically conductive fitting, comprising:
a. a housing having passageway walls forming a passageway extending in front and rear directions;
b. an optical device situating in the rear wall of said passageway and facing toward the front direction of said passageway,
c. an elongated cylinder placing in said passageway with an open end aiming at said optical device and another open end pointing toward the front direction of said passageway for engaging with said mating device such that the optical fiber of said mating device being guided through said elongated cylinder for proper positioning to communicate with said optical device, and that the electrically conductive fitting of said mating device staying in contact with said elongated cylinder,
d. said elongated cylinder being made of electrically conductive material having contact pin extending through the passageway wall to outside of said housing for mounting onto a circuitry,
whereby connection to said mating device will be made for optical signal and electrical current transmission.

6. The opto-electro adaptor of claim 5 further including at least one sheet metal electrically conductive element affixing to an area of the passageway wall that presses against a designated electrically conductive contact of said mating device when engages, with contact pin extending through said passageway wall to outside of said housing for mounting onto a circuitry.
